(19) United States
(12) Patent Application Publication
(10) Pub. No.: US 2015/0066432 A1
(43) Pub. Date: Mar. 5, 2015

(54) COMPUTING DEVICE AND METHOD FOR MANAGING WARNING INFORMATION OF THE COMPUTING DEVICE

(71) Applicants: HON HAI PRECISION INDUSTRY CO., LTD, New Taipei (TW); HONG FU JIN PRECISION INDUSTRY (Shenzhen) CO., LTD, Shenzhen (CN)

(72) Inventors: CHUNG-I LEE, New Taipei (TW); YI-GUO WANG, Shenzhen (CN); QIAN-CHENG MA, Shenzhen (CN); JIAN HUANG, Shenzhen (CN); HONG-BO LIANG, Shenzhen (CN); ZHENG-LAI DING, Shenzhen (CN)

(73) Assignees: HON HAI PRECISION INDUSTRY CO., LTD, New Taipei (TW); HONG FU JIN PRECISION INDUSTRY (Shenzhen) CO., LTD, Shenzhen (CN)

(21) Appl. No.: 14/062,916

(22) Filed: Oct. 25, 2013

(30) Foreign Application Priority Data
Aug. 28, 2013 (CN) 2013103792879

(51) Int. Cl. G06F 11/30

(52) U.S. Cl. CPC G06F 11/3072; G06F 11/3058
USPC 702/185

(57) ABSTRACT

In a method for managing warning information of a computing device, when an equipment fault is detected, the method determines whether or not a unique identification code of the detected equipment fault is recorded in a list. If the unique identification code of the detected equipment fault is recorded in the list, the method determines whether or not a frequency of occurrences of the detected equipment fault exceeds a preset value. If the frequency of occurrences of the detected equipment fault does not exceed a preset value, warning information of the detected equipment fault is generated. Otherwise, if the frequency of occurrences of the detected equipment fault exceeds a preset value, the method stops generating the warning information.

### BACKGROUND

1. Technical Field

Embodiments of the present disclosure relate to a computing device and a method for managing warning information of the computing device.

2. Description of Related Art

Warning information is generated during a working process of a computing device to prompt that a equipment of the computing device is faulty. For example, a normal humidity range of a working environment of the computing device is 10%-40%. Warning information may be generated if the humidity detected by a humidity sensor is 41% or above. However, the detected humidity may float between 41% and 39%, which generates too many warning information many times.

### BRIEF DESCRIPTION OF THE DRAWINGS

FIG. 1 is a block diagram of one embodiment of a computing device having a warning information management system.

FIG. 2 is a block diagram of one embodiment of function modules of the warning information management system of FIG. 1.

FIG. 3 is a flowchart of one embodiment of a method for managing warning information of the computing device of FIG. 1.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module,” as used herein, refers to logic embodied in hardware or firmware, or to a collection of software instructions, written in a programming language. In one embodiment, the program language may be Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, flash memory, and hard disk drives.

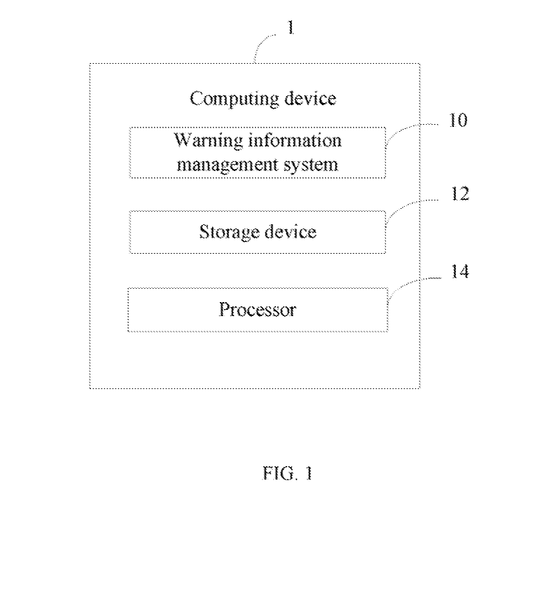

FIG. 1 is a block diagram of one embodiment of a computing device 1 including a warning information management system 10. The computing device 1 comprises a storage device 12, and at least one processor 14. In the embodiment, the computing device 1 may be a personal computer, a sever, a notebook computer, a cellular phone, a master production scheduler (MPS) machine, or a personal digital assistant (PDA), for example.

In one embodiment, the storage device 12 (non-transitory storage device) may be an internal storage system, such as a random access memory (RAM) for the temporary storage of information, and/or a read only memory (ROM) for the permanent storage of information. In some embodiments, the storage device 12 may be an external storage system, such as an external hard disk, a storage card, or a data storage medium.

The processor 14 may include a processor unit, a microprocessor, an application-specific integrated circuit, and a field programmable gate array, for example.

In one embodiment, the warning information reducing system 10 includes a plurality of function modules which include computerized codes or instructions that can be stored in the storage device 12 and executed by the processor 14 to provide a method for managing warning information of the computing device 1.

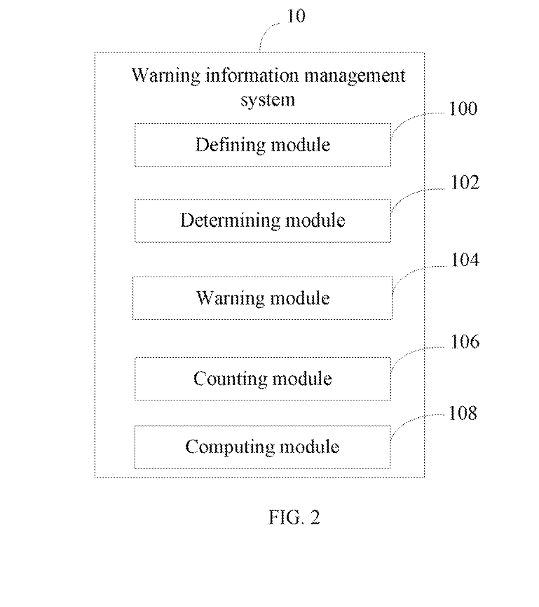

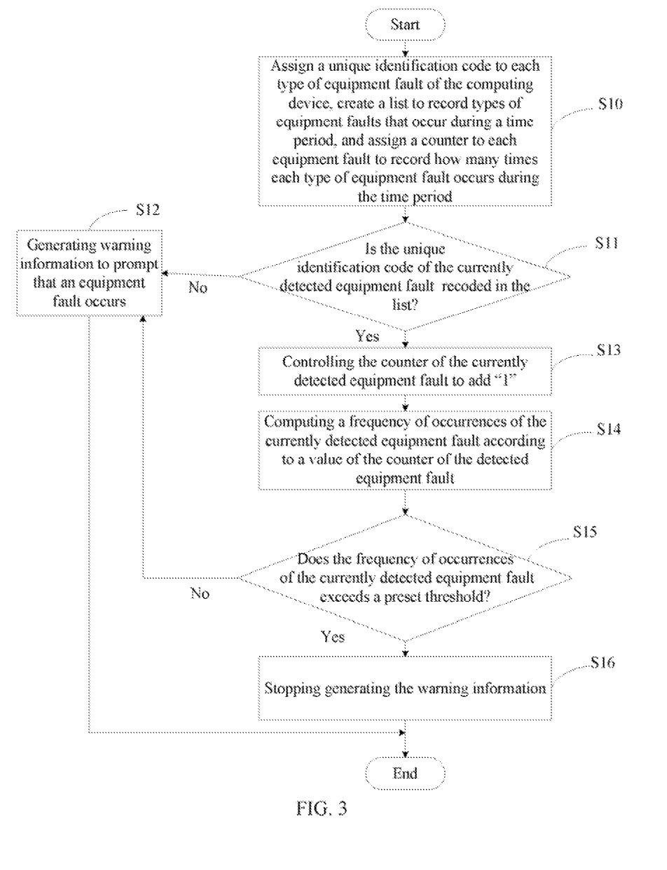

FIG. 2 is a block diagram of one embodiment of function modules of the warning information management system 10. In the embodiment, the warning information management system 10 includes a definition module 100, a recoding module 102, a determination module 104, a warning module 106, a counting module 108, and a computing module 110. The modules may comprise computerized codes in the form of one or more programs that are stored in the storage device 12 and executed by the processor 14 to provide functions for implementing the warning information management system 10. The functions of the function modules are illustrated in FIG. 3 and described below.

FIG. 3 illustrates a flowchart of one embodiment of a method for managing warning information of the computing device 1 of FIG. 1. Depending on the embodiment, additional steps may be added, others removed, and the ordering of the steps may be changed.

In step S10, the definition module 100 assigns a unique identification code to each type of equipment fault of the computing device 1, creates a list to record the types of equipment faults that occur during a time period, and assigns a counter to each equipment fault to record how many times each type of equipment fault occurs during the time period. The time period is set by a user. In one embodiment, the unique identification code is composed of an equipment number and an equipment fault number. The equipment number and the equipment fault number may be composed of letters or numerals, and may be predefined by the user of the computing device 1. The equipment fault is defined as an error of a hardware component of the computing device 1, such as a CPU error, or a memory error, that occurs during the time period while the computing device 1 is running

In step S11, the determination module 104 determines whether or not the recording module 102 records the unique identification code of a currently detected equipment fault in the list. If the recording module records the unique identification code of the currently detected equipment fault in the list, step S13 is implemented. Otherwise, if the recording module does not record the unique identification code of the currently detected equipment fault in the list, step S12 is implemented. In the embodiment, if the recording module 102 records the equipment number and equipment fault number of the currently detected equipment fault in the list, the determination module 100 determines that the recording module records the unique identification code of the currently detected equipment fault in the list. Otherwise, if the recording module 102 does not record the equipment number and equipment fault number of the currently detected equipment fault in the list, the determination module 104 determines that the recording module 102 does not record the unique identification code of the currently detected equipment fault in the list.

In step S12, the warning module 106 generates warning information to prompt that an equipment fault occurs in the computing device 1.

In step S13, the counting module 108 controls the counter of the currently detected equipment fault to add a number “1,” i.e., i=i+1, where the parameter “i” represents the value of the counter of the currently detected equipment fault.

In step S14, the computing module 110 computes a frequency of occurrences of the currently detected equipment fault according to a value of the counter of the equipment fault. In the embodiment, the frequency of occurrences of the currently detected equipment fault equals the value of the counter of the currently detected equipment fault divided by the time period.

In step S15, the determination module 104 determines whether or not the frequency of occurrences of the currently detected equipment fault exceeds a preset threshold. If the frequency of occurrences of the currently detected equipment fault exceeds the preset threshold, step S16 is implemented. Otherwise, if the frequency of occurrences of the currently detected equipment fault does not exceed the preset threshold, step S12 is repeated. In the embodiment, the preset threshold is set by the user of the computing device 1.

In step S16, the warning module 106 stops generating the warning information.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A computing device, comprising:
at least one processor; and
a storage device storing a computer program including instructions that, which executed by the at least one processor, causes the at least one processor to:
assign a unique identification code to each type of equipment fault of the computing device, create a list to record types of equipment faults that occur during a time period, and assign a counter to each equipment fault to record how many times each type of equipment fault occurs during the time period;
determine whether or not the unique identification code of a currently detected equipment fault is recoded in the list;
generate warning information to prompt that an equipment fault occurs, if the unique identification code of the currently detected equipment fault is not recoded in the list;
control the counter of the currently detected equipment fault to add “1” if the unique identification code of the currently detected equipment fault is recoded in the list;
compute a frequency of occurrences of the currently detected equipment fault according to a value of the counter of the equipment fault;
determine whether or not the frequency of occurrences of the currently detected equipment fault exceeds a preset threshold; and
stop generating the warning information if the frequency of occurrences of the currently detected equipment fault exceeds the preset threshold.

2. The computing device according to claim 1, wherein the frequency of occurrences of the currently detected equipment fault equals the value of the counter of the currently detected equipment fault divided by the time period.

3. The computing device according to claim 1, wherein each of the unique identification codes is composed of an equipment number and an equipment fault number, and each equipment number and equipment fault number is composed of letters or numerals.

4. A method for managing warning information of a computing device, the method comprising:
assigning a unique identification code to each type of equipment fault of the computing device, creating a list to record types of equipment faults that occur during a time period, and assigning a counter to each equipment fault to record how many times each type of equipment fault occurs during the time period;
determining whether or not the unique identification code of a currently detected equipment fault is recoded in the list;
generating warning information to prompt that an equipment fault occurs, if the unique identification code of the currently detected equipment fault is not recoded in the list;
controlling the counter of the currently detected equipment fault to add “1” if the unique identification code of the currently detected equipment fault is recoded in the list;
computing a frequency of occurrences of the currently detected equipment fault according to a value of the counter of the equipment fault;
determining whether or not the frequency of occurrences of the currently detected equipment fault exceeds a preset threshold; and
stopping generating the warning information, if the frequency of occurrences of the currently detected equipment fault exceeds the preset threshold.

5. The method according to claim 4, wherein the frequency of occurrences of the currently detected equipment fault equals the value of the counter of the currently detected equipment fault divided by the time period.

6. The method according to claim 4, wherein each of the unique identification codes is composed of an equipment number and an equipment fault number, and each equipment number and equipment fault number is composed of letters or numerals.

7. A non-transitory computer-readable storage medium having stored thereon instructions being executed by a processor of a computing device, causes the processor to perform a method for managing warning information of the computing device, the method comprising:
assigning a unique identification code to each type of equipment fault of the computing device, creating a list to record types of equipment faults that occur during a time period, and assigning a counter to each equipment fault to record how many times each type of equipment fault occurs during the time period;
determining whether or not the unique identification code of a currently detected equipment fault is recoded in the list;
generating warning information to prompt that an equipment fault occurs, if the unique identification code of the currently detected equipment fault is not recoded in the list;
controlling the counter of the currently detected equipment fault to add “1” if the unique identification code of the currently detected equipment fault is recoded in the list;
computing a frequency of occurrences of the currently detected equipment fault according to a value of the counter of the equipment fault;
determining whether or not the frequency of occurrences of the currently detected equipment fault exceeds a preset threshold; and
stopping generating the warning information, if the frequency of occurrences of the currently detected equipment fault exceeds the preset threshold.

8. The storage medium according to claim 8, wherein the frequency of occurrences of the currently detected equipment fault equals the value of the counter of the currently detected equipment fault divided by the time period.

9. The storage medium according to claim 9, wherein each of the unique identification codes is composed of an equipment number and an equipment fault number, and each equipment number and equipment fault number is composed of letters or numerals.
